(19) United States
(12) Patent Application Publication
(10) Pub. No.: US 2022/0121278 A1
(43) Pub. Date: Apr. 21, 2022

(54) CONNECTED DEVICE WITH EYE TRACKING CAPABILITIES

(71) Applicant: ELLCIE-HEALTHY, VILLENEUVE LOUBET (FR)

(72) Inventor: PHILIPPE PEYRARD, ANTIBES (FR)

(21) Appl. No.: 17/420,665

(22) PCT Filed: Jan. 6, 2020
(86) PCT No.: PCT/EP2020/050151

§ 371 Date: Jul. 2, 2021

Related U.S. Application Data
(60) Provisional application No. 62/788,453, filed on Jan. 4, 2019.

(51) Int. Cl. G06F 3/01; G02B 27/00; G02B 27/01; G06T 7/80; G06T 7/70; G06T 19/00

(52) U.S. Cl. CPC G06F 3/013; G02B 27/0093; G02B 27/0172; G02B 2027/0178; G06T 7/80; G06T 7/70; G06T 19/006; G02B 27/0176

(57) ABSTRACT

A system to assess a gaze direction including a device featuring a rim for holding a glass and having two IR emitters in separated locations of the rim. Each IR emitter having a light emission cone and emitting a beam directed toward the eye of the user to produce a lighting spot on the cornea. The rim further includes an IR receiver. The two IR emitters are activated one at a time in a sequence.

### RELATED APPLICATIONS

This application is a § 371 application of PCT/EP2020/050151 filed Jan. 6, 2020, which claims the benefit of U.S. Provisional Application No. 62/788,453 filed Jan. 4, 2019, each of which is incorporated herein by reference in its entirety.

### TECHNICAL FIELD

The invention belongs to the field of connected wearable devices. In a specific embodiment the invention pertains to a connected pair of eyeglasses featuring sensors and processing means for detecting a situation of reduced alertness of their wearer, and for generating several levels of alarm when such a situation is encountered. In order to improve the detection of such a situation the invention implements eye tracking capabilities. Such eye tracking capabilities may also be implemented in other devices such a viewfinder on a wearable device.

### BACKGROUND OF THE INVENTION

This application is an improvement of the device disclosed in U.S. application Ser. Nos. 15/852,554, and 16/178,365 (now U.S. Pat. Nos. 10,152,869 and 10,964,190, respectively) which are hereby included by reference and commonly owned by Applicant of instant application.

The effects of a drop of alertness are likely to have serious consequences when the person experiencing it drives a vehicle or a machine, the risk extending to the passengers of the vehicle or to the facilities and people close to the machine.

The risks involved in those situations are significantly reduced if suitable measures are completed on time. Thus, as for instance, the driver of a vehicle easily overestimates its state of alertness, to the point of getting caught by a real slumber. A simple alarm directed to his intention or to the passengers in the vehicle allows to make him aware of his drowsiness state and to foster him to stop driving.

U.S. Pat. No. 10,152,869 B2 which is hereby included by reference, discloses a pair of connected eyeglasses featuring infrared sensors and able to detect a state of reduce alertness of their user by analyzing eyeblinks patterns. This device of the prior art performs satisfactorily.

It actually detects the inception of drowsiness of the wearer while the wearer, most of the time, is still confident in its capability to drive safely.

When drowsiness starts to set up, there is little time left before it worsens and leads to a risky situation. It is therefore an object of the invention to provide an even earlier detection of a reduced alertness state with improved reliability.

Besides eyeblinks analysis, alertness may be assessed by analyzing the direction of the gaze, and variations of this direction with time. Analyzing the direction of the gaze also allows to check out that, as for instance, the driver of a vehicle is actually focused on the road and is not distracted by another occupation such as looking at its cell phone.

Analyzing and detecting the direction of the gaze also enables further applications beyond the measurement of a state of alertness.

Measuring the gaze direction may be performed either by a camera or by an infrared detector, in fact a plurality of infrared detectors. In both cases the eye is lit by an infrared source, and the detection is performed by the difference in reflectivity of the sclera, the iris and the pupil. Therefore, when the direction of the gaze changes the intensity of the reflected light is changed.

In order to actually detect the direction of the gaze, an image processing is performed in the case of a detection by a camera, or, when an infrared sensor is used, the lightening incident beam is focused in one or multiple, crosshairs like narrow bands, in combination with a plurality of detectors, thus allowing an accurate assessment of the gaze direction.

Typically, narrow rectangular IR light spots of a rectangular shape or about 3 mm×1 mm arranged in a cross like manner are projected on the user cornea by IR emitters equipped with a specific lens.

However, these devices and methods of the prior art are implementing a large number of sensors and detectors and are requiring quite a large computing power, leading to a high electrical power consumption when implemented in a wearable device, and an unsightly design when implemented in spectacles.

The device disclosed in U.S. Pat. No. 10,152,869 B2, although featuring an IR emitter and an IR receiver is designed for detecting eyeblinks, that is to say a change of reflectivity when the incident IR beam is reflected by the cornea or by the eyelid. For that device to work properly, independently of the user, and taking into account the manufacturing tolerances of the eyeglasses frame, the incident IR beam shall be wide enough, and therefore cannot be used as such to assess the gaze direction. On the other hand, using more focused IR beams in the device disclosed in U.S. Pat. No. 10,152,869 B2, such as to obtain crosshairs lightening lines on the cornea, makes the device unreliable for the detection of eyeblinks, and may lead to unreliable results when variations such as user's morphology, manufacturing tolerances of the eyeglasses frame or the way the user is wearing the spectacles are taken into account.

### OBJECT AND SUMMARY OF THE INVENTION

It is an object of the invention to solve the disadvantages of the prior art and to provide a system comprising a device like a connected pair of eyeglasses capable of reliably assessing both eyeblink patterns and gaze direction with a limited set of sensors while being cost effective, reliable and robust vis-a-vis manufacturing tolerances when manufactured in large batches.

To this end the invention pertains to a system for assessing a gaze direction of a user comprising a device featuring a rim for holding a glass in front of a user's eye and comprising 2 IR emitters in separated locations of the rim, each IR emitter having a light emission cone and emitting a beam directed toward the eye of the user so as to create a lighting spot on the cornea, the rim further comprising an IR receiver, wherein the 2 IR emitters are activated one at a time in sequence.

As the two IR beams are located in separated locations, they emit with a different incident angle with respect to the surface of the eye, and with the use of a single detector, these differences in the reflected light seen from the IR receiver, combined with the sequential activation of the IR emitters allow to both reliably measure the direction of the gaze while using wide lighting spots on the cornea and therefore being also suitable for detecting eyeblinks while minimizing the influence of the user morphology and manufacturing tolerances of the frame on the results.

In a specific embodiment of the system of the invention the device is a pair of eyeglasses with hinged stems comprising a right rim and a left rim for holding the glasses wherein each rim comprises on the hinge side 2 IR emitters each having a light emission cone and emitting a lighting spot on the cornea, a first IR emitter in the upper part of the rim emitting a first beam directed towards the eye of the user, a second IR emitter in the lower side of the rim emitting a second beam directed towards the eye of the user, each rim comprising an IR receiver placed in the upper side of the rim beside the first emitter, wherein the 4 IR emitters are activated one at a time in sequence.

Using a similar set up on each rim of the eyeglasses further improves the reliability and the accuracy of the device. Being also suitable for detecting eyeblinks, such a pair of eyeglasses allows an early detection of a drop of alertness of their user, by combining those measurements with gaze variation patterns.

The accuracy and the effectiveness of the system may be further improved considering the following embodiments that can be implemented individually or in any combination thereof.

According to an embodiment the light emission cone of a first emitter on a rim is different than the light emission cone of a second emitter on the rim. The result is that the two IR light spots projected from each emitter on the cornea are of different diameters thus increasing the change of the received reflected light seen from the IR receiver when the direction of the gaze is changed.

Advantageously, the angular wideness of the light emission cone of the emitter set in the lower part of a rim is comprised between 9° and 40°, and the angular wideness of the light emission cone of the emitter set in an upper part of the rim is equal or more than 70°.

The lighting spot generated by the IR emitter set in the lower part of the rim is less likely to be disturbed by eyelashes or some facial expressions, that location is therefore better suited for the narrow beam emission.

According to another embodiment, the first and the second IR emitter locations and orientations on the rim are set so that the lighting spots are projected in a different area of the cornea.

According to another embodiment the intensity of the light emitted by a first emitter of the rim is set to a different value than the intensity of the light emitted by a second emitter of the rim.

Advantageously, the IR receiver is located beside an IR emitter and separated from the IR emitter by an opaque optical barrier. This implementation avoids so called “cross talk” between the receiver and the emitter and improves the accuracy of the intensity measurement of the reflected beams, while also enabling a more compact design. According to an improved embodiment the device comprises a triaxial accelerometer and a gyro sensor, the signals of these sensors being used to assess the user head position. Combining the information of the user head position with the information about the gaze direction enables to better assess the direction towards which the user is actually looking.

In a preferred embodiment the system comprises a smartphone connected to the pair of eyeglasses and comprising a software for the calibration of the system.

The invention also pertains to a method of calibration by a user, implementing the eyeglasses, the smartphone and the calibration software, and a specific target configured to be hold by the eyeglasses, the method comprising the steps of:
setting up the target on the eyeglasses and wearing the eyeglasses;
launching the software on the smartphone and making movements taught by the software with the smartphone, the user following the smartphone camera by eye movements while the emitters and the receivers are operated;
collecting the relative position and orientation of the smartphone relative to the target and the signal from the receiver during the preceding sequence;
comparing the received signal with the relative position of the smartphone with the target; and
updating the correspondence of the intensity of the signal received by the receivers with the gaze direction according to the results of the preceding step.

The implementation of that calibration method improves the accuracy and robustness of the gaze direction measurement, without requiring any complex or heavy equipment. Such a calibration may be performed by the user itself or with the aid of another person.

### BRIEF DESCRIPTION OF DRAWINGS

The application is disclosed hereafter according to its preferred embodiment that are in no way limiting and with reference to FIGS. 1 to 6, in which:

FIG. 1 shows in a perspective view an exemplary embodiment of the device of the system of the invention in the form of a pair of spectacles;

FIG. 2 is an inside view of the device of FIG. 1;

FIG. 3 shows according to a perspective view an example of the lighting spots projected on the eyes of the user according to a first embodiment;

FIG. 4 shows another exemplary embodiment of lighting spots projected on the eyes of the user;

FIG. 5 shows an exemplary embodiment of an accessory to be set on top of the eyeglasses for performing calibration operations, according to a perspective view; and

FIG. 6 showcases an example of performing a calibration with the system of the invention.

### DETAILED DESCRIPTION OF THE EMBODIMENTS

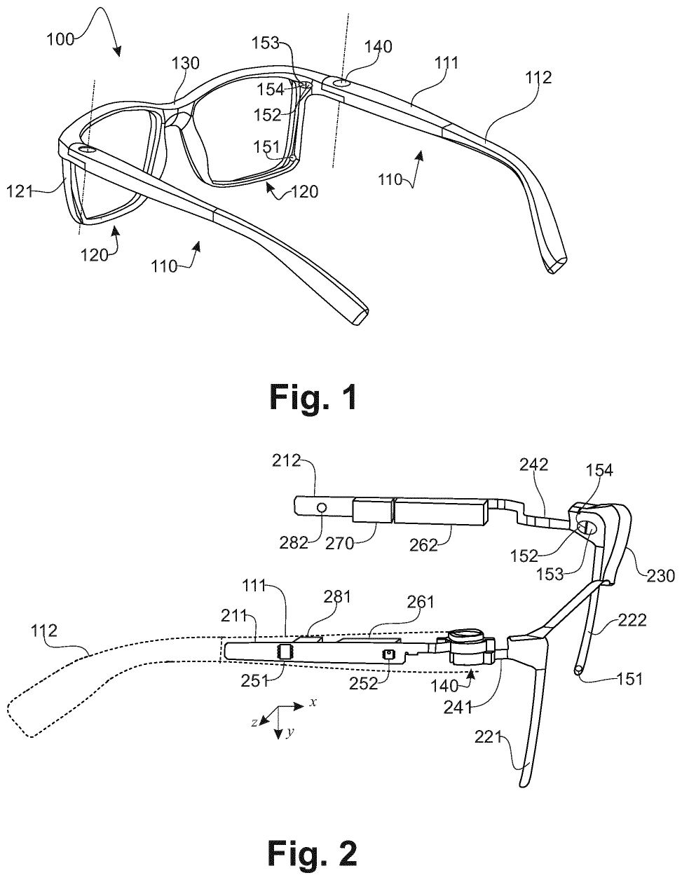

FIG. 1, according to an exemplary embodiment the sensors of the system of the invention are borne by a pair of spectacles (100), featuring two hinged stems (110), two rims (120) holding the prescription or not glasses, said rims (120) being linked by a bridge (130) resting on the nose of the user when the spectacles are worn. According to this exemplary embodiment, the stems comprise two parts. A first part (111), so-called front part, extends from the stem hinge (140) along about half of the stem length. The second part (112) of the stem, so-called aft part, is connected to the first part (111), e.g., by clipping. This second part rests on the ear of the user, and includes or not a curved temple tip, also called earpiece, pursuant to different styles of eyeglasses.

According to this exemplary embodiment, the front part of the stem bears electronic modules, while the second part (112), or aft part, does not include any electronics. Therefore, this second part is adapted to the morphology of a user, in the same way as for any conventional eyeglasses, by using a shorter or a longer second part (112), or even by distorting it by heating.

The rims comprise two parts, the outer part (121) of the rims, extending substantially between the hinge and the bottom of the rims, bears sensors, including two IR emitters (151, 153) and an IR receiver (152). The lower part and the inner part of the rims (120), up to the bridge (130), are free from any electronics and eases the mounting of any type of glass.

According to this exemplary embodiment, the rims are made of plastic and fully surround the lenses. As a for instance, the lenses are set up in the spectacles by heating the lower part of the rims and their connections to the bridge.

FIG. 2, according to an exemplary embodiment, the eyeglasses of the system of the invention comprise several circuit boards (211, 212, 221, 222), on which the various sensors, acquisition and calculation means as well as data transmitting means, are welded or snapped.

According to this exemplary embodiment, the electronic boards are housed inside the front part of the stems and inside of the outer parts of the rims. As a for instance, those parts of the stems and rims are made of a plastic material such as a polyamide or acetate or of a composite material comprising a thermosetting or thermoplastic matrix reinforced by a fibrous charge of glass, carbon or natural fibers such as bamboo or linen, for more lightweight and strength.

These envelopes provide both mechanical shielding and weatherproof of the electronics, and are available in a variety of colors, different surface textures and different shapes.

The electronic boards (211, 212, 221, 222) are connected to each other by flexible buses (241, 242, 230), comprising a central bus (230) extending between the right side and the left side of the spectacles and running through the inside of the upper parts of the rims and the bridge, and side buses (241, 242) connecting the boards (211, 212) located inside the front parts of the stems, with the boards (221, 222) located inside the outer edges of the rims. The side buses (241, 242) are running through the hinges (140) of the stems, said hinges being specifically designed for this purpose.

A processing and calculation unit is advantageously distributed between two modules (261, 262) set respectively on the electronic boards of the right stem and the left stem.

As a non-restrictive example, the module (261) of the right stem comprises a microprocessor and memory means, including a program for acquiring the signals from the sensors, and for processing signals and calculating the relevant parameters, whereas the module (262) of the left stem, collects the signals of the sensors placed on that same stem and their transmission towards the module of the right stem, manages the power supply, the charge of the battery (270) and the communications, whether wired or wireless with other devices, in particular towards a smartphone, a computer, or a WiFi® gateway.

Advantageously, one of the modules comprises means to control the power emission of each LED, meaning the switch on and the switch off of each LED as well as controlling the emitting power. As a result, using a device connected to the modules, a user, using a suitable application, may change the conditions of light emission of each LED and such conditions may be stored in the memory means. The eyeglasses finally comprise means of alarm distributed between the stems, for example a colored led (282) and a buzzer (281).

According to an embodiment a miniaturized connector (not represented), for example of the micro-USB type is integrated in one of the stems and allows data exchange with other devices, via a wire connection, and the recharging of the battery (270).

In a specific embodiment, the module (261) comprising the microprocessor also comprises a geolocation chip.

In specific embodiments, the eyeglasses of the invention comprise additional sensors such as a triaxial accelerometer (251) and a barometric sensor (252). The triaxial accelerometer is advantageously coupled with a gyro-sensor, this kind of sensor combining a triaxial accelerometer and a gyro-sensor is currently commercially available in a same MEM package.

A first IR emitter (153), in the form of an IR emitting LED is set at the upper part of the rim, so that the emitted beam is oriented towards the eye of the user. The IR receiver (152) is set beside the first IR emitter, and separated from that first IR emitter by an optical barrier (154) made of an opaque sheet of plastic. The IR receiver measures the intensity of the IR light projected by the IR emitters and reflected by the eye of the user, either by the cornea area: sclera, iris or pupil or part thereof, when the eye is open, or by the eyelid when the eye is closed or partially closed. The optical separation avoids that the lit LED of the first emitter influences the measurement of the IR receiver.

The upper IR emitting LED (153) lights the eye from the top with a given incidence angle, projecting a light spot on the cornea which is reflected by the spherical surface of the eye. For assessing the gaze direction, the light of the upper emitter and reflected by the cornea is used in combination with the reflected light from the second emitter. However, the angular wideness of the light cone emitted by the upper emitter is wider, thus providing a wider spot making it more effective to detect eyeblinks. According to a preferred embodiment, the lower IR emitter (151) projects a light spot on the cornea by a beam coming from the bottom, arriving on the spherical surface of the eye with a different incidence angle as compared with the first IR light emitter (153).

Therefore, even if the two IR emitters (151, 153) are of the same characteristics, like same emission power, same angle of emission, same focusing location, the reflected intensities of the two beams on the cornea as seen by the IR receiver, will be different for a given direction of the gaze, and will be influenced differently when the direction of the gaze is changed.

This layout with two IR emitters, one on the top and one on the bottom of the rim, and a single IR receiver, is reproduced on each rim. Therefore, when the direction of the gaze changes, the intensity of the reflected light measured by the right IR receiver and by the left IR receiver will be different.

Measuring the light reflected by the cornea on the right eye and on the left eye of the user while each eye is lit in sequence by each IR emitter, gives an intensity pattern comprising 4 values, each gaze direction giving a different pattern, even if the spots lighting the cornea are relatively wide. This feature is advantageously used by the invention to detect the direction of the gaze, by associating to each intensity pattern a certain gaze direction: straight, top, bottom, right, left, said pattern being identified by preliminary experiments conducted on different subjects with different eyeglasses to take into account the variations in morphologies and manufacturing tolerances.

The identified patterns are for instance stored in the memory means of the calculation and processing unit of the eyeglasses, and comparing the measured reflection pattern to those recordings allows to assess the direction of the gaze.

The accuracy and the resolution of the detection may be further improved by implementing the specific embodiments disclosed hereafter.

As an exemplary embodiment the upper IR emitter (153) is a bare IR emitting LED, not featuring any focusing lens, therefore, the emission cone is wide with an angle of emission at mid intensity of approximately 70° or more. This wide emission angle results in a light spot projected on the eye of the user of approximately 10 mm in diameter, depending on the user's morphology and on the way the spectacles are worn by the user.

As mentioned hereinabove such a wide spot is also effective for detecting eyeblinks with a reduced sensitivity to the user morphology, to the way the spectacles are worn and to the facial expressions.

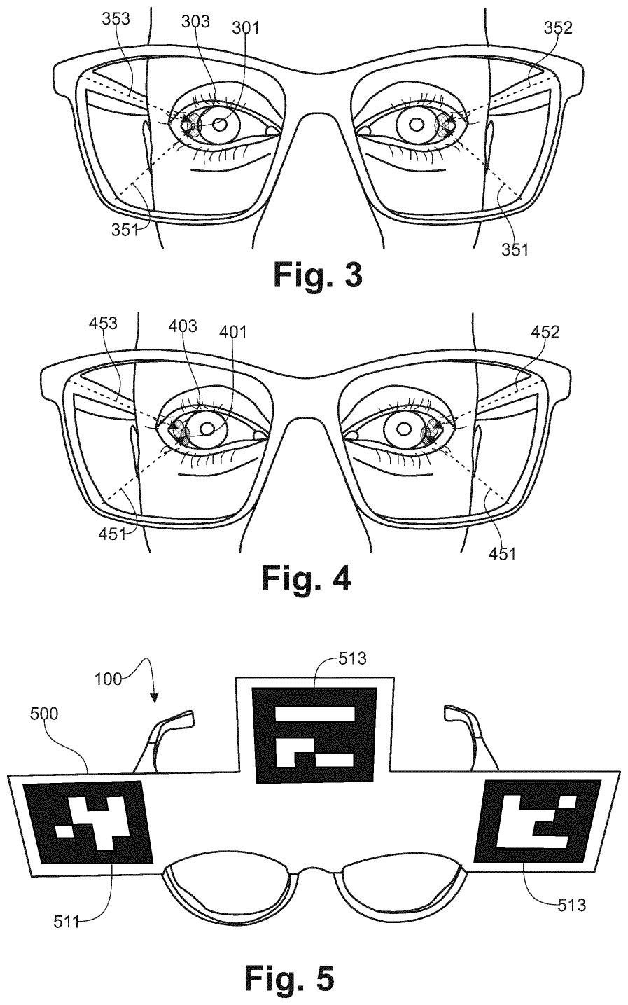

The lower IR emitter (151) is an IR LED equipped with a lens, focusing the beam and reducing the angle of the emitted cone of light. The angle of emission at mid intensity is therefore 40° or less, preferably comprised between 9° and 40°. This narrower emission angle results in a light spot projected on the eye of the user with a diameter comprised between 1.5 mm and 6 mm depending on the lens set on the LED, on the user's morphology and on the way the spectacles are worn by the user. FIG. 3, according to a first embodiment the IR beam (353) emitted by the upper IR emitter is directed at the external side of the eye and produces a wide spot (303) of approximately 1 0 mm in diameter. This spot is wide enough to reliably detect an eyeblink.

The IR beam (351) emitted by the lower IR emitter is directed in the same area of the eye than the upper beam (353) and produces a light spot (301) of reduced diameter.

FIG. 3 shows the user looking straight forward, on the right eye the smaller spot (301) is reflected by the sclera, while the larger spot (303) is reflected by both the sclera and the iris in this example. The situation is similar on the left eye.

Starting from the situation of FIG. 3, if the user looks to the right, the right eye iris will progressively penetrate in the wide spot (303) changing the reflected light since the reflection of the iris is different from the reflection of the sclera, while the smaller spot (301) is still reflected by the sclera. If the user looks further to the right, the iris will cross the borders of the smaller spot (301) while the pupil will cross the borders of the larger spot (303), resulting in a change of the reflected light for both spots. Meanwhile, on the left eye, when the user looks to the right the iris and the pupil are moving away from both spots which are both reflected by the sclera.

If the user looks to the top or the bottom, the reflection will also change because of the spherical shape of the eye changing the angle of incidence of each beam on the eye, and also because of the circular shape of the iris thus penetrating more or less into each spot during such an eye movement.

Once again, the effect of such a change in the gaze direction will be different on the reflection of the lower beam and on the reflection of the upper beam as well as between the right eye and the left eye.

The person skilled in the art understands that having two different spots diameter allows a more accurate detection when the different parts of the eye are crossing the border of each spot.

The emitter with the narrower emission cone is preferably set on the lower part of the rim in order for the emitted beam not to be intercepted by eyelashes.

Therefore, considering the reflection of each spot on the two rims, any gaze direction will translate in a reflection intensity pattern of the 4 spots.

FIG. 4, according to another embodiment the two IR emitters of each rim are emitting with a similar cone of light emission but are focused to a slightly different area of the eye. In this nonlimiting example, the upper beam (453) is focused further towards the external corner of the eye producing a light spot (403) of approximately 6 mm in diameter, while the focusing of the lower IR emitter beam (451) is shifted towards the center of the eye, also producing a light spot (401) of approximately 6 mm of diameter.

The person skilled in the art will understand that the light spots (403, 401) may overlap or not, and that, in a variant, the diameters of the spots may be different. Whatever the embodiment, the acquisition of the reflection intensity pattern is realized by lighting the 4 IR emitters one by one according to a defined sequence. As a for instance such a sequence may be:
lighting the right upper IR emitter;
lighting the right lower emitter;
lighting the left upper emitter; and
lighting the left lower emitter.

Each emitter is activated during a fraction of a second, ranging between 10⁻⁵ and 10⁻³ second, and the appropriate IR receiver (right or left) measures the reflected intensity corresponding to the reflection of each emitter taken individually, thus giving a reflection intensity pattern.

Each set of 4 acquisitions is preferably performed at a periodicity ranging from 50 Hz to 100 Hz, preferably 70 Hz, therefore at a much higher pace than any eye movement or eyeblink.

The reflectivity of the eyelid is much higher than the reflectivity of any part of the sclera, the iris and the pupil. The duration of an involuntary eyeblink, used to detect drowsiness, is comprised between 0.1 and 0.3 seconds, a longer eye closure time is a symptom of an advance drowsiness.

Therefore, when an eyeblink occurs during an acquisition sequence, it is easily detected and processed accordingly.

Unlike prior art devices using crosshairs beams focused on the eye that are difficult to implement on an item produced in large batch, because of manufacturing tolerances and variation in users' morphologies, the system of the invention implements two beams of relatively large dimension making it more robust with regard to the various sources of scattering.

Furthermore, these wide spots enable a reliable detection of eyeblinks during the same sequence of acquisition.

Therefore, information derived from the variation of the gaze direction can be compiled with information related to eyeblinks as disclosed in U.S. Pat. No. 10,152,869 B2, in a composite index of reduced alertness, said composite index being used to trigger an early alarm of loss of alertness of the user.

While the layout described hereinabove allows to measure the direction of the gaze of the user, said user may also look in different directions looking almost straight forward by moving its head, which can also be a sign of reduced alertness.

The eyeglasses of the system of the invention advantageously feature a triaxial accelerometer and a gyro-sensor. These sensors are used, as for instance, to detect a head drop triggered by a micro slumber of the user.

Advantageously, the same sensors may be used in combination with the gaze direction detecting sensors, to assess the pitch, roll and yoke of the head of the user, providing a more accurate assessment of the direction towards which the user is actually looking at, thus giving additional information about its state of alertness. As a for instance, if the position of the head of a user supposed to drive a car is detected as turned to the right while the gaze direction is turned to the left, or similarly if the head direction is pointing at the bottom while the gaze direction is found as pointing to the top, there is a contradiction meaning that the driver is distracted and not really focused on the road. If such a situation lasts too long or is repeated too many times in a given timeframe, an alarm is triggered.

In order for the gaze direction detection to work reliably it is better for the system to be calibrated individually, meaning for each pair of user/device.

Such a calibration makes it possible to correct variations in the manufacturing of the spectacles et in the IR emitting LED as well as IR receiver and will take into account the user morphology as well as its way of wearing the spectacles.

The calibration method is advantageously designed so that a user, eventually with the help of a peer, may proceed to that calibration using its smartphone.

To this end, the system of the invention comprises a smartphone featuring an application dedicated to its calibration.

The smartphone is connected to the pair of eyeglasses via a wired connection, through the miniature USB port, or a wireless connection, e.g., via a Bluetooth® connection.

Therefore, the smartphone may be used through an appropriate application to change the light emitting conditions of each LED so as to get an optimal result as well as to adapt the characteristics of the reflection patterns corresponding to any specific direction of the gaze.

As a first and straightforward calibration, the user is simply looking straightforward without blinking while wearing the spectacles. The LEDs are lit in sequence and the reflected intensity measured. Data are exchanged between the spectacles and the smartphone.

The application on the smartphone compares the results to specific values and tolerances stored in a memory. If the measurements are laying in the correct range, the calibration process moves to the next step.

If the measurements are outside the acceptable range, then the measurement are further analyzed in order to detect a malfunctioning device, i.e., one the LEDs or a receiver is not working properly, or to adjust the light emitting power of the LEDs. As a result of that calibration each LED may be set to a different emitting power. Once the first calibration step is completed a fine tuning of the system may be performed to improve the accuracy of the system. To this end, FIG. 5, a specific accessory (500) is set on top of the pair of eyeglasses (100). That accessory is, e.g., made of a printed sheet of carboard or plastic and comprises means for clipping on the pair of eyeglasses. According to this exemplary embodiment, the accessory comprises 3 targets (511, 512, 513) consisting in high contrast patterns printed on a face of the accessory. Two of the targets (511, 512) are located on each side of the rims and one target (513) in the center, over the nose bridge.

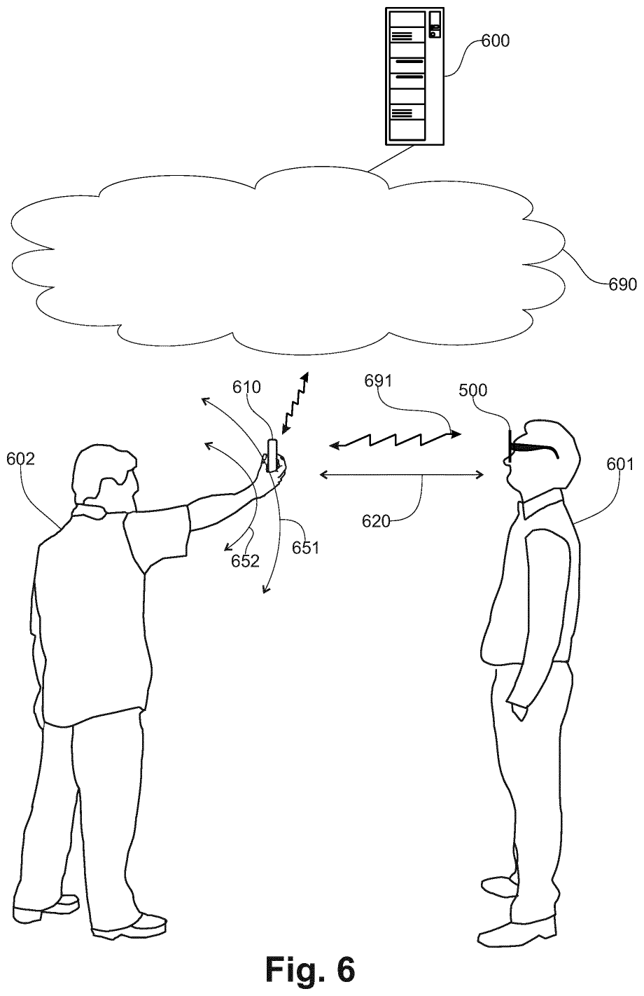

FIG. 6, the second calibration step is better performed with the help of an assistant such as a friend (602).

In order to perform this calibration, the user (601) is wearing the pair of spectacles holding the accessory (500).

The user stays in front of the assistant. The assistant is holding a smartphone (610), featuring a camera, and provided with an application collecting and exchanging data with the pair of spectacles via a Bluetooth® connection (691).

The assistant (602) is pointing the smartphone camera at the user (601) at a distance (620) of approximately 1.50 m. The assistant is guided by the application on the smartphone and will mainly executes ample and slow movements from top to bottom (651) and from left to right (652) with the smartphone, while keeping the camera of the smartphone pointed towards the user (601).

The user (601) follows the smartphone camera with the eyes without moving the head or the body. The acquisition sequence of eye tracking is launched on the spectacles and the data, i.e., the light intensity measured by the two IR receivers, is sent to the smartphone via the Bluetooth® connection.

During the procedure, the image of the user head and of the accessory featuring the targets is acquired by the smartphone camera and recorded. An image analysis is performed on the images of the targets allowing to know the relative position the spectacles with respect to the smartphone camera and therefore to assess the direction of the gaze of the user.

At the end of the procedure a table giving the relative position of the smartphone, therefore the assumed direction of the gaze, with intensity patterns of the reflected IR lights on each IR receiver is obtained, and is used to finely tune the association of reflected light patterns to each gaze direction. Once this association is determined it is sent by the smartphone to the memory means of the eyeglasses and used to assess the gaze direction.

The required calculation may be performed in the smartphone application itself or, in an alternative embodiment, part or all of these calculations may be performed by a server (600) connected to the internet (690). The smartphone being also connected to the internet (690) as a for instance through a WiFi® gateway or through a telephone network and exchanging data with the smartphone.

It shall be noticed that those calibration procedures do not require any bench or specific device, but only the accessory holding the targets, and may be performed by the user itself from time to time.

The description hereinabove and the exemplary embodiments show that the aim of the invention is reached and that the system of the invention enables to assess the gaze direction of a user as well as the measurement of eyeblinks patterns while using a reduced of sensors.

The configuration of the lighting spots of the cornea as well as the simple calibration procedure make the system robust vis-a-vis manufacturing tolerances and the user morphology, while being cost effective.

The system of the invention allows to add the analysis of gaze direction or gaze direction variation to the assessment of a loss of alertness of the user, thus improving the device of the prior art disclosed in U.S. Pat. No. 10,152,869 B2.

The person skilled in the art will understand that being able to assess a gaze direction may be used to further applications than loss of alertness detection. As a for instance a gaze direction assessment may also be used for piloting various devices with the eye.

1-12. (canceled)

13. A system to assess a gaze direction of a user comprising a device featuring a rim for holding a glass in front an eye of a user and comprising two IR emitters in separated locations of the rim, each IR emitter having a light emission cone and emitting a beam directed toward the user's eye of the user so as to provide a lighting spot on a cornea of the user, the rim further comprising an IR receiver, wherein the two IR emitters are activated one at a time in sequence.

14. The system of claim 13, wherein a first IR emitter is located on a lower side of the rim and a second IR emitter is located on an upper side of the rim.

15. The system of claim 13, wherein the device is a pair of eyeglasses with hinged stems comprising a right rim and a left rim for holding glasses wherein each of the right rim and left rim comprises the two IR emitters and IR receiver on a hinge side, a first IR emitter in an upper side of a corresponding rim emitting a first beam, a second IR emitter in a lower side of the corresponding rim emitting a second beam and the IR receiver in the upper side of the corresponding rim beside the first IR emitter, the first beam and the second beam being directed towards the eye of the user, wherein the four IR emitters are activated one at a time in sequence.

16. The system of claim 13, wherein the light emission cone of the first IR emitter is different than the light emission cone of the second IR emitter.

17. The system of claim 14, wherein an angular wideness of the light emission cone of the first IR emitter is between 9° and 40°, and an angular wideness of the light emission cone of the second IR emitter is equal to or more than 70°.

18. The system of claim 13, wherein locations and orientations of the first IR emitter and the second IR emitter on the rim are set so that the lighting spots are projected in a different area of the cornea.

19. The system of claim 13, wherein an intensity of the beam emitted by the first IR emitter is set to a different value than an intensity of the beam emitted by the second IR emitter.

20. The system of claim 13, wherein the IR receiver is located beside one of the two IR emitters and is separated from said IR emitter by an opaque optical barrier.

21. The system of claim 13, wherein the device further comprises a triaxial accelerometer and a gyro sensor, signals of the triaxial accelerometer and the gyro sensor being used to assess a head position of the user.

22. The system of claim 14, wherein the device is a pair of eyeglasses and further comprising a smartphone connected to the pair of eyeglasses, the smartphone comprising a software to calibrate the system.

23. The system of claim 22, further comprising an accessory holding a target configured to be clipped on top of the pair of eyeglasses.

24. A method for calibrating by the user of the system of claim 23, comprising:
setting up the accessory holding the target on the pair of eyeglasses worn by the user;
launching the software on the smartphone comprising a camera and moving the smartphone as instructed by the software, operating the first IR emitter, the second IR emitter and the IR receiver to acquire movements of the eye of the user following the camera of the smartphone;
collecting relative position and orientation of the smartphone relative to the target and a signal from the IR receiver during the acquisition of the movements of the eye of the user,
comparing the signal from the IR receiver with a position of the smartphone relative to the target to provide a comparison result; and
updating a correspondence of an intensity of a signal received by the IR receiver with the gaze direction according to the comparison result.
